(19) United States
(12) Patent Application Publication
(10) Pub. No.: US 2022/0268264 A1
(43) Pub. Date: Aug. 25, 2022

(54) HYDROGEN GAS COMPRESSION DEVICE

(71) Applicant: SAEMCHAN ENERGY CO., LTD., Seoul (KR)

(72) Inventor: Kwang Chan AN, Seoul (KR)

(21) Appl. No.: 17/423,226

(22) PCT Filed: Jan. 9, 2020
(86) PCT No.: PCT/KR2020/000365

§ 371 Date: Feb. 18, 2022

(30) Foreign Application Priority Data
Jan. 31, 2019 (KR) 10-2019-0012458

(51) Int. Cl. F04B 35/01; F04B 39/00; F04B 37/12; F04B 27/02; F16H 19/04

(52) U.S. Cl. CPC F04B 35/01; F04B 39/0005; F04B 37/12; F04B 27/02; F16H 19/04

(57) ABSTRACT

The present invention relates to a hydrogen gas compression device. The hydrogen gas compression device according to an embodiment of the present invention is a hydrogen gas compression device for converting low-pressure hydrogen gas introduced into at least one compression chamber into high-pressure hydrogen gas and discharging the high-pressure hydrogen gas, the hydrogen gas compression device including: a pinion member which performs a rotating motion by a power unit; at least one rack member which has one end portion engaged with the pinion member and performs a reciprocating linear motion according to the rotating motion of the pinion member; at least one compression member which has a central portion connected to the other end portion of each of the at least one rack member and performs a reciprocating motion according to the reciprocating linear motion of each of the at least one rack member to reduce or enlarge the volume of each of the at least one compression chamber; and a housing that has at least one hole portion into which the at least one compression member is inserted in a reciprocable state, and forms the at least one compression chamber, into which the low-pressure hydrogen gas is introduced, in an area of the at least one hole portion on a front end portion side of each of the at least one compression member.

### TECHNICAL FIELD

The present invention relates to a hydrogen gas compression device, and more particularly, to a hydrogen gas compression device in which the overall size can be relatively reduced and carry-over of oil hardly occurs.

### BACKGROUND ART

A hydrogen gas compression device transports hydrogen generated in oil refining and chemical processes to a gas supplier through a gas pipe, and allows the gas supplier to compress and store the hydrogen in a hydrogen transportation cartridge vehicle. The hydrogen gas compression device receives gas at a first stage suction pressure (20-25 kg/cm²·g), boosts the received gas at a second stage compression pressure (200 kg/cm²·g), compresses hydrogen supplied from a hydrogen gas production facility under high pressure, and supplies the compressed hydrogen to automobiles or fuel cells. The hydrogen gas compression device is a device for increasing the efficiency of hydrogen gas which is alternative energy developed for preventing an increase in energy price due to a decrease in fossil fuel reserves and an increase in consumption amount with respect to a change in global environment, the necessity of developing alternative energy due to the crisis of energy supply and demand, and an increase in environmental pollution index due to transportation energy, which accounts for a large part of the domestic energy demand.

A hydrogen gas compression device according to the related art is illustrated in FIGS. 1 and 2. Referring to FIGS. 1 and 2, a hydrogen gas compression device according to the related art may be provided with: a driving unit including a crankshaft and a piston 11 which reciprocates in a stroke chamber when the crankshaft rotates, such as an engine of an automobile; and a compression unit including a diaphragm 12 which compresses hydrogen gas as the pressure of oil between the diaphragm 12 and the piston 11 increases.

Specifically, as illustrated in FIG. 1, when the piston 11 ascends to the highest point, the pressure of the oil between the diaphragm 12 and the piston 11 increases and the introduced low-pressure hydrogen gas is compressed. As illustrated in FIG. 2, when the piston 11 descends to the lowest point, the opposite phenomenon occurs.

However, the hydrogen gas compression device of FIGS. 1 and 2 according to the related art, as the driving unit is provided with the crankshaft, the overall size of the hydrogen gas compression device becomes larger. In order to continuously rotate the crankshaft, a relatively large electric motor is required. Thus, it becomes a factor of cost increase, and power consumption increases.

On the other hand, although not illustrated in the drawings, a method of compressing hydrogen gas using a cylinder rod driven by a hydraulic cylinder is disclosed. In this case, carry-over of a certain amount of oil may occur. Such exposure of the carryover oil will cause oil to solidify, which ultimately leads to a failure of a hydrogen gas compression system.

Accordingly, there is a need for a hydrogen gas compression device in which the size of the entire hydrogen gas compression device in which the overall size can be relatively reduced and carry-over of oil hardly occurs.

### SUMMARY OF INVENTION

### Technical Problem

An object of the present invention is to provide a hydrogen gas compression device in which the overall size can be relatively reduced and oil carry-over hardly occurs.

The objects of the present invention are not limited to the above object, and other objects that are not mentioned herein will be clearly understood by those of ordinary skill in the art from the following description.

### Solution to Problem

In order to achieve the above objects, a hydrogen gas compression device according to an embodiment of the present invention is a hydrogen gas compression device for converting low-pressure hydrogen gas introduced into at least one compression chamber into high-pressure hydrogen gas and discharging the high-pressure hydrogen gas, the hydrogen gas compression device including: a pinion member which performs a rotating motion by a power unit; at least one rack member which has one end portion engaged with the pinion member and performs a reciprocating linear motion according to the rotating motion of the pinion member; at least one compression member which has a central portion connected to the other end portion of each of the at least one rack member and performs a reciprocating motion according to the reciprocating linear motion of each of the at least one rack member to reduce or enlarge the volume of each of the at least one compression chamber; and a housing which has at least one hole portion into which the at least one compression member is inserted in a reciprocable state, and forms the at least one compression chamber, into which the low-pressure hydrogen gas is introduced, in an area of the at least one hole portion on a front end portion side of each of the at least one compression member.

In this case, the at least one rack member may include a height adjustment section for compensating for a height difference between the one end portion and the other end portion.

In addition, each of the at least one compression member may include a piston connected to the other end portion of each of the at least one rack member.

In addition, each of the at least one compression member may include: a pressing portion connected to the other end portion of each of the at least one rack member; and a diaphragm pressed by the pressing portion.

In addition, the pressing portion provided in each of the at least one compression member may include: a pressing space formed between each of the at least one rack member and the diaphragm provided in each of the at least one compression member; and a fluid filling the pressing space.

Specific matters of other embodiments are included in the detailed description and drawings.

### Advantageous Effects of Invention

According to an embodiment of the present invention, it is possible to provide a hydrogen gas compression device in which the overall size can be relatively reduced and oil carry-over hardly occurs.

The effects of the present invention are not limited to the above-described effect, and other effects that are not mentioned herein will be clearly understood by those of ordinary skill in the art from the appended claims.

### BRIEF DESCRIPTION OF DRAWINGS

FIG. 1 is a schematic diagram illustrating a driving mechanism of a hydrogen gas compression device (when a piston is located at the highest point) according to the related art.

FIG. 2 is a schematic diagram illustrating a driving mechanism of a hydrogen gas compression device (when a piston is located at the lowest point) according to the related art.

FIG. 3 is a perspective view illustrating a hydrogen gas compression device according to a first embodiment of the present invention.

FIG. 4 is a perspective cross-sectional view illustrating the hydrogen gas compression device according to the first embodiment of the present invention.

FIG. 5 is a front view illustrating the hydrogen gas compression device according to the first embodiment of the present invention.

FIG. 6 is a diagram for explaining the operation of the hydrogen gas compression device according to the first embodiment of the present invention.

FIG. 7 is a front view illustrating a modification of the hydrogen gas compression device according to the first embodiment of the present invention.

FIG. 8 is a front view illustrating a hydrogen gas compression device according to a second embodiment of the present invention.

FIG. 9 is a diagram for explaining the operation of the hydrogen gas compression device according to the second embodiment of the present invention.

### DESCRIPTION OF EMBODIMENTS

Hereinafter, preferred embodiments of the present invention will be described with reference to the accompanying drawings, so that those of ordinary skill in the art can easily carry out the present invention.

In describing the embodiments, descriptions of technical contents that are well known in the technical field to which the present invention pertains and are not directly related to the present invention will be omitted. By omitting unnecessary description, the present invention can be described more clearly without obscuring the gist of the present invention.

For the same reason, some elements in the accompanying drawings are exaggerated, omitted, or schematically illustrated. Also, the size of each element does not entirely reflect the actual size. The same reference numerals are assigned to the same or corresponding elements in the drawings.

In addition, the expressions and predicates used herein with respect to the terms such as device or element directions (for example, “front”, “back”, “up”, “down”, “top”, “bottom”, “left”, “right”, “lateral”, and the like) are only used to simplify the description of the present invention, and do not simply indicate or imply that the related device or element should have a particular direction.

The present invention has been made to provide a hydrogen gas compression device in which the overall size can be relatively reduced and oil carry-over hardly occurs.

To this end, a hydrogen gas compression device according to an embodiment of the present invention is a hydrogen gas compression device for converting low-pressure hydrogen gas introduced into at least one compression chamber into high-pressure hydrogen gas and discharging the high-pressure hydrogen gas, the hydrogen gas compression device including: a pinion member which performs a rotating motion by a power unit; at least one rack member which has one end portion engaged with the pinion member and performs a reciprocating linear motion according to the rotating motion of the pinion member; at least one compression member which has a central portion connected to the other end portion of each of the at least one rack member and performs a reciprocating motion according to the reciprocating linear motion of each of the at least one rack member to reduce or enlarge the volume of each of the at least one compression chamber; and a housing which has at least one hole portion into which the at least one compression member is inserted in a reciprocable state, and forms the at least one compression chamber, into which the low-pressure hydrogen gas is introduced, in an area of the at least one hole portion on a front end portion side of each of the at least one compression member.

Hereinafter, the present invention will be described with reference to the drawings for explaining a hydrogen gas compression device according to embodiments of the present invention.

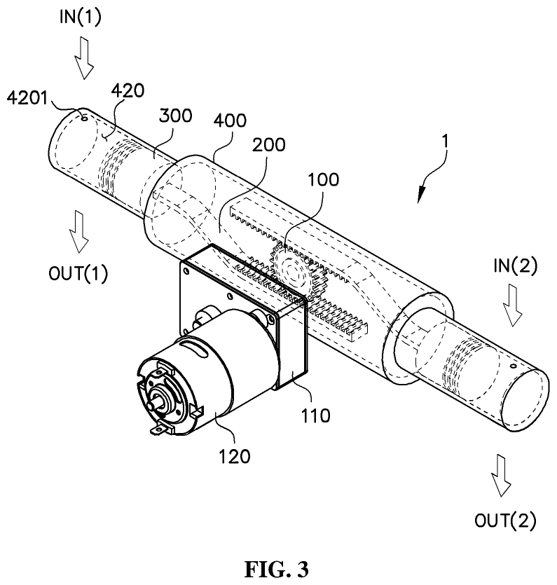

Hereinafter, a hydrogen gas compression device according to a first embodiment of the present invention will be described with reference to FIGS. 3 to 7.

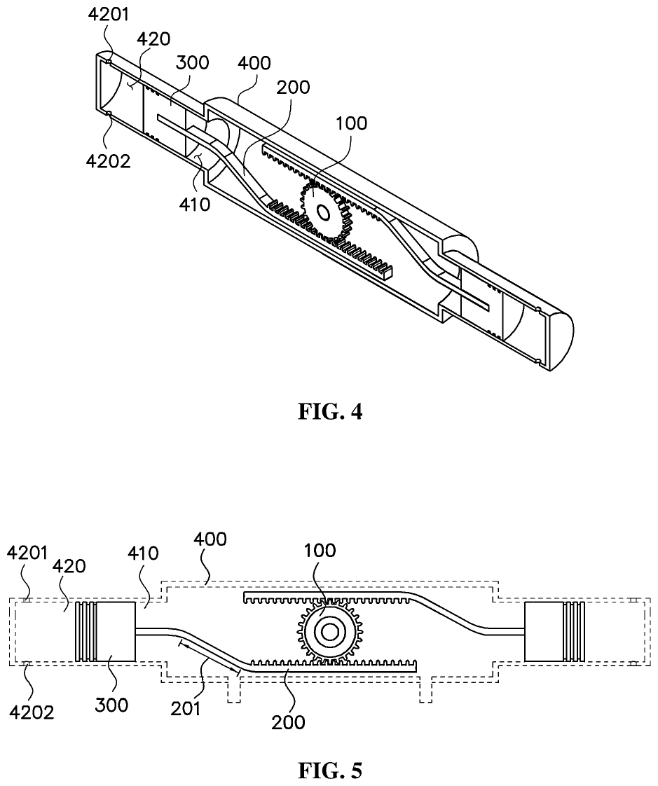

FIG. 3 is a perspective view illustrating the hydrogen gas compression device according to the first embodiment of the present invention, FIG. 4 is a perspective cross-sectional view illustrating the hydrogen gas compression device according to the first embodiment of the present invention, and FIG. 5 is a front view illustrating the hydrogen gas compression device according to the first embodiment of the present invention.

Referring to FIGS. 3 to 5, the hydrogen gas compression device 1 according to the first embodiment of the present invention is a hydrogen gas compression device 1 for converting low-pressure hydrogen gas introduced into a compression chamber 420 into high-pressure hydrogen gas and discharging the high-pressure hydrogen gas and may include a pinion member 100, a rack member 200, a compression member 300, and a housing 400.

First, in the first embodiment of the present invention, the pinion member 100 is connected to a power unit and is rotated by the power unit to provide a rotating motion as a driving force for reciprocating linear motion of the rack member 200 to be described later.

At this time, the power unit may include a driving motor 120 and a reducer 110 to rotate the pinion member 100 in a forward or reverse direction. When the driving motor 120 is operated, the pinion member 100 rotates while decelerating through the reducer 110.

In the first embodiment of the present invention, the rack member 200 is configured to provide a driving force for a reciprocating motion required so that the compression member 300 to be described later converts low-pressure hydrogen gas introduced into the compression chamber 420 into high-pressure hydrogen gas.

Specifically, the rack member 200 has one end portion engaged with the pinion member 100 and the other end portion connected to the central portion of the compression member 300. The rack member 200 performs a reciprocating linear motion according to the rotating motion of the pinion member 100 so that the compression member 300 reciprocates.

In this case, the rack member 200 has one end portion connected to the pinion member 100 and the other end portion inserted into a hole portion 410 of the housing 400 to be described later or positioned at an adjacent position, and may provide a driving force for a reciprocating motion to the compression member 300.

At this time, when the height of the pinion member 100 engaged with one end portion of the rack member 200 is different from the height of the hole portion 410, the rack member 200 may include a height adjustment section 201 for compensating for a height difference between one end portion engaged with the pinion member 100 and the other end portion connected to the central portion of the compression member 300.

For example, as illustrated in FIGS. 3 to 5, the height adjustment section 201 may be formed in an oblique shape. Although not illustrated in the drawings, the height adjustment section 201 may be formed in a concavely or convexly curved or bent shape. However, the present invention is not limited thereto.

On the other hand, the rack member 200 is provided with two rack members as illustrated in FIGS. 3 to 5. The two rack members 200 may be engaged and driven with one pinion member 100. Although not illustrated in the drawings, the rack member 200 may be provided with one rack member and engaged and driven with the pinion member 100. However, the present invention is not limited thereto.

In the first embodiment of the present invention, the compression member 300 reduces or enlarges the volume of the compression chamber 420 to convert low-pressure hydrogen gas introduced into the compression chamber 420 into high-pressure hydrogen gas.

Referring to FIGS. 3 to 5, the compression member 300 may be formed in a piston (or cylinder) shape. The compression member 300 may be connected to the other end portion of the rack member 200 to perform a reciprocating motion according to the reciprocating linear motion of the rack member 200.

Specifically, when a portion of the compression member 300 connected to the other end portion of the rack member 200 is referred to as a rear end portion of the compression member 300, the compression member 300 may compress low-pressure hydrogen gas introduced into the compression chamber 420 through a front end portion.

At this time, when the compression member 300 is provided with two rack members 200 as illustrated in FIGS. 3 to 5 and the two rack members 200 are engaged and driven with one pinion member 100, the compression member 300 may be provided with two compression members so as to be respectively connected to the other end portions of the two rack members 200. However, the present invention is not limited thereto.

In the first embodiment of the present invention, the housing 400 is configured to form the compression chamber 420, which is a closed space into which low-pressure hydrogen gas is introduced, together with the front end portion of the compression member 300.

Specifically, the housing 400 has a hole portion 410 into which the compression member 300 is inserted in a reciprocable state in an axial direction, and the compression chamber 420 into which low-pressure hydrogen gas is introduced is formed in an area of the hole portion 410 on the front end portion side of the compression member 300.

In this case, when the two compression members 300 are respectively connected to the other end portions of the two rack members 200 as illustrated in FIGS. 3 to 5, the housing 400 may include two compression chambers 420 and two hole portions 410 into which the two compression members 300 are respectively inserted. In addition, a low-pressure hydrogen gas inlet 4201 and a high-pressure hydrogen gas outlet 4202 may be formed in the two compression chambers 420, respectively.

On the other hand, FIGS. 3 to 5 illustrate that the pinion member 100, the rack member 200, and the compression member 300 are all embedded in the housing 400, but the present invention is not limited thereto. The design may be changed into various structures forming the compression chamber 420 together with the front end portion of the compression member 300.

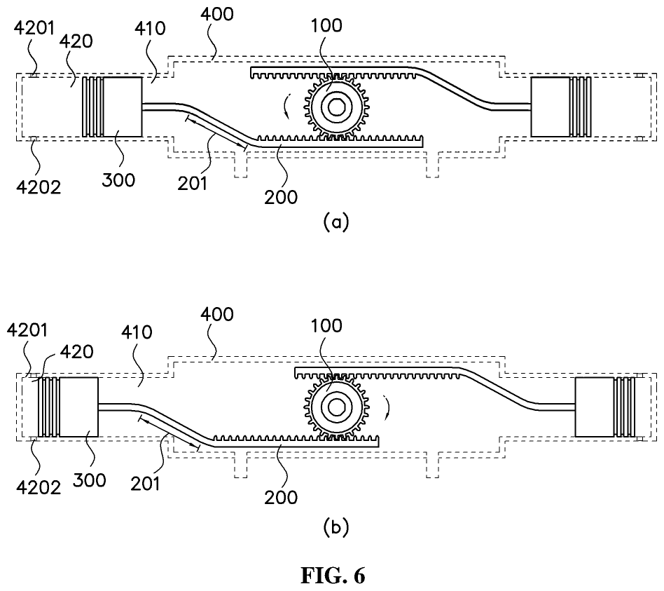

FIG. 6 is a diagram for explaining the operation of the hydrogen gas compression device according to the first embodiment of the present invention.

Referring to FIG. 6, assuming that the clockwise rotation of the pinion member 100 is referred to as forward rotation, when the pinion member 100 rotates in the forward direction in a state of being positioned as illustrated in FIG. 6(a), the rack member 200 and the compression member 300 connected to the rack member 200 may move forward in the direction of the compression chamber 420 as illustrated in FIG. 6(b), and low-pressure hydrogen gas introduced into the compression chamber 420 may be compressed, converted into high-pressure hydrogen gas, and then discharged.

On the contrary, when the pinion member 100 rotates in a reverse direction that is a counterclockwise direction, the rack member 200 and the compression member 300 may move backward in the opposite direction of the compression chamber as illustrated in FIG. 6(a) so that new low-pressure hydrogen gas can be introduced into the compression chamber 420.

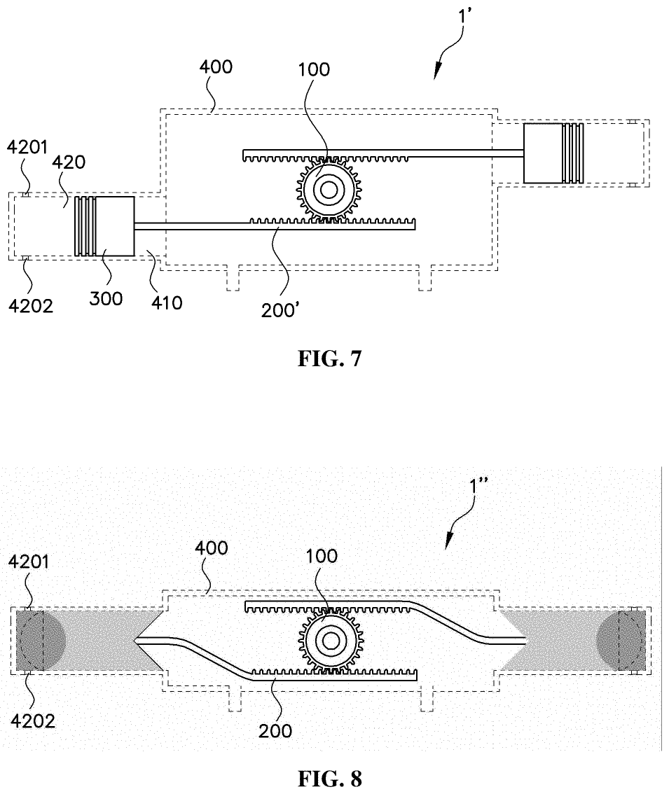

FIG. 7 is a front view illustrating a modification of the hydrogen gas compression device according to the first embodiment of the present invention.

A hydrogen gas compression device 1′ illustrated in FIG. 7 has the same configuration as the hydrogen gas compression device 1 illustrated in FIGS. 3 to 6, except for the form of a housing 400 and a rack member 200′.

Referring to FIG. 7, the hole portion 410 of the housing 400 may be formed to the same height as the height of the pinion member 100 engaged with one end portion of the rack member 200′. Accordingly, the rack member 200′ may be formed linearly without the height adjustment section 201 for compensating for the height difference.

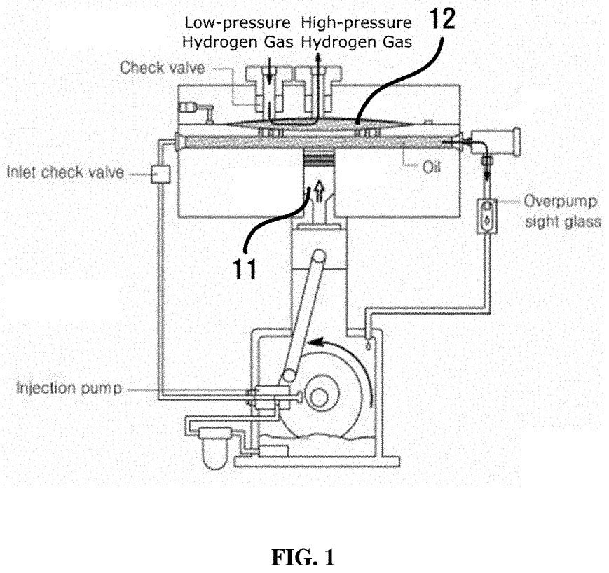

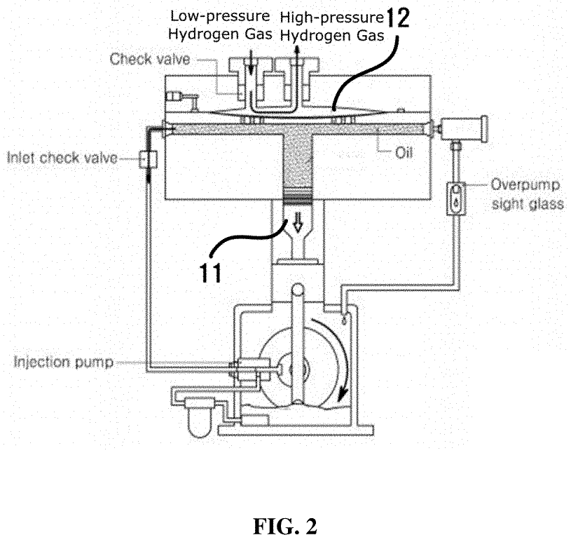

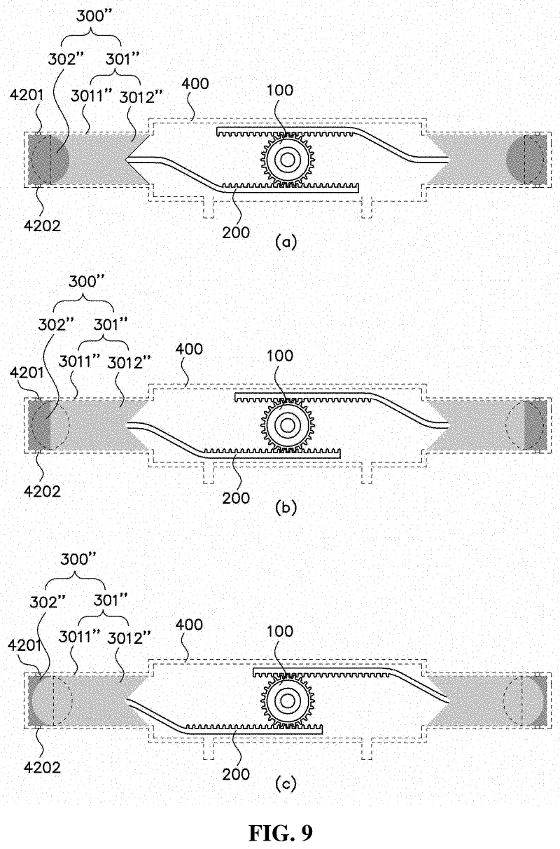

Hereinafter, a hydrogen gas compression device 1″ according to a second embodiment of the present invention will be described with reference to FIGS. 8 and 9. For convenience of explanation, the description of the same structure as the hydrogen gas compression device 1 illustrated in FIGS. 1 to 7 will be omitted, and only differences will be described below.

FIG. 8 is a front view illustrating the hydrogen gas compression device according to the second embodiment of the present invention.

The hydrogen gas compression device 1″ illustrated in FIG. 8 has the same configuration as the hydrogen gas compression device 1 illustrated in FIGS. 1 to 7, except for a compression member 300″.

Referring to FIG. 8, in the hydrogen gas compression device 1″ according to the second embodiment of the present invention, the compression member 300″ may include a pressing portion 301″ and a diaphragm 302″.

First, the pressing portion 301″ is connected to the other end portion of the rack member 200 and transmits the reciprocating linear motion of the rack member 200 as a driving force for the reciprocating motion of the diaphragm 302″.

For example, the pressing portion 301″ may include a pressing space 3011″ formed between the rack member 200 and the diaphragm 302″ and a fluid 3012″ such as oil filling the pressing space 3011″. As the pressure of the fluid 3012″ such as oil increases, the diaphragm 302″ may be pressed.

As another example, the pressing portion 301″ may include an oscillating structure configured to receive the reciprocating linear motion of the rack member 200 and perform an oscillating motion.

When a portion of the compression member 300″ connected to the other end portion of the rack member 200 is referred to as a rear end portion of the compression member 300″, the compression member 300″ may compress low-pressure hydrogen gas introduced into the compression chamber 420 through a front end portion.

At this time, when the compression member 300″ is provided with two rack members 200 as illustrated in FIGS. 3 to 5 and the two rack members 200 are engaged and driven with one pinion member 100, the compression member 300″ may be provided with two compression members so as to be respectively connected to the other end portions of the two rack members 200. However, the present invention is not limited thereto.

FIG. 9 is a diagram for explaining the operation of the hydrogen gas compression device according to the second embodiment of the present invention.

Referring to FIG. 9, assuming that the clockwise rotation of the pinion member 100 is referred to as forward rotation, when the pinion member 100 gradually rotates in the forward direction in a state of being positioned as illustrated in FIG. 9(a), the rack member 200 may move forward in the direction of the compression chamber 420 as illustrated in FIGS. 9(b) and 9(c). Accordingly, the fluid 3012″ located in the pressing portion 301″, that is, the pressing space 3011″ is compressed to press the diaphragm 302″. Thus, the volume of the compression chamber 420 may be reduced, and low-pressure hydrogen gas introduced into the compression chamber 420 may be compressed, converted into high-pressure hydrogen gas, and then discharged.

On the contrary, when the pinion member 100 rotates in a reverse direction that is a counterclockwise direction, the rack member 200 may move backward in the opposite direction of the compression chamber as illustrated in FIG. 9(a) so that new low-pressure hydrogen gas can be introduced into the compression chamber 420.

As such, according to the hydrogen gas compression devices 1, 1′, and 1″ according to the embodiments of the present invention, the overall size of the hydrogen gas compression device can be reduced and oil carry-over hardly occurs.

On the other hand, in the present specification and the drawings, preferred embodiments of the present invention are disclosed. Although certain terms are used, these terms are only used in a general sense to easily explain the technical content of the present invention and to help the understanding of the invention, and are not intended to limit the scope of the present invention. It will be obvious to those of ordinary skill in the art that other modifications based on the technical idea of the present invention may be made thereto.

### INDUSTRIAL APPLICABILITY

The present invention is applicable to the technical field related to a hydrogen gas compression device, and more particularly, to a hydrogen gas compression device in which the overall size can be relatively reduced and carry-over of oil hardly occurs.

1. A hydrogen gas compression device for converting low-pressure hydrogen gas introduced into at least one compression chamber into high-pressure hydrogen gas and discharging the high-pressure hydrogen gas, the hydrogen gas compression device comprising:
a pinion member which performs a rotating motion by a power unit;
at least one rack member which has one end portion engaged with the pinion member and performs a reciprocating linear motion according to the rotating motion of the pinion member;
at least one compression member which has a central portion connected to the other end portion of each of the at least one rack member and performs a reciprocating motion according to the reciprocating linear motion of each of the at least one rack member to reduce or enlarge the volume of each of the at least one compression chamber; and
a housing which has at least one hole portion into which the at least one compression member is inserted in a reciprocable state, and forms the at least one compression chamber, into which the low-pressure hydrogen gas is introduced, in an area of the at least one hole portion on a front end portion side of each of the at least one compression member,
wherein each of the at least one rack member includes a height adjustment section for compensating for a height difference between the one end portion and the other end portion so that the other end portion is connected to the central portion of each of the at least one compression member.

2. The hydrogen gas compression device of claim 1, wherein each of the at least one compression member includes a piston connected to the other end portion of each of the at least one rack member.

3. The hydrogen gas compression device of claim 1, wherein each of the at least one compression member includes:
a pressing portion connected to the other end portion of each of the at least one rack member; and
a diaphragm pressed by the pressing portion.

4. The hydrogen gas compression device of claim 3, wherein the pressing portion provided in each of the at least one compression member includes:
a pressing space formed between each of the at least one rack member and the diaphragm provided in each of the at least one compression member; and
a fluid filling the pressing space.
